(19) United States
(12) Patent Application Publication
(10) Pub. No.: US 2008/0114487 A1
(43) Pub. Date: May 15, 2008

(54) METHOD AND APPARATUS FOR SUPPLY CHAIN MANAGEMENT USING PALLET-WORKSTATION AND WORKSTATION-WORKSTATION COMMUNICATION

(75) Inventors: Francesca Schuler, Des Plaines, IL (US); Thomas S. Babin, Lake Zurich, IL (US); Andreas Schaller, Wiesbaden (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/558,535

(22) Filed: Nov. 10, 2006

(51) Int. Cl. G06F 7/00; B65G 1/00; B65D 19/44

(52) U.S. Cl. 700/217; 414/273; 235/375

(57) ABSTRACT

Operation of a supply chain having a number of workstation that process items supported by pallets is managed using a sub-central controller, a number of pallet devices, each associated with a pallet, and one or more workstation devices, each associated with a workstation. A workstation device is operable to communicate with the pallet devices to acquire pallet information and to process the pallet information based upon rules provided by the sub-central controller. The workstation device acts on the processed pallet information to modify the operation of the supply chain. A central controller may be used to coordinate activities of multiple sub-central controllers.

### CROSS-REFERENCE TO RELATED APPLICATIONS

This application is related to U.S. patent application Ser. No. 11/323,546, attorney docket number CML02604T, entitled “Method and System for Request Processing in a Supply Chain”, filed Dec. 30, 2005; to U.S. patent application Ser. No. 11/323,516, attorney docket number CML02553T, entitled “Method For Resource Management in a Supply Chain”, filed Dec. 30, 2005; and to U.S. patent application Ser. No. ______, attorney docket number CML02729T, entitled “Method and Apparatus for Communication with a Transport Structure in Transit”, filed even date herewith, each assigned to the assignee hereof.

### BACKGROUND

Supply chain management is the process of planning, implementing, and controlling the operations of a supply chain. A supply chain is a process or series of processes for providing one or more resources or products to customers. For example, a supply chain can include raw material procurement or the procurement of component parts, manufacturing products, distribution of products or services, inventory management, and product sales. A supply chain can exist entirely within a single organization or can extend to a number of organizations. Effective implementation of a supply chain makes a business enterprise competitive. Business enterprises generally use computer-implemented management systems to model supply chains and generate plans to provide resources to customers.

Inventory management is an essential part of a supply chain. There are various inventory management systems through which resources are managed in a supply chain. For example, a centralized management system has a central controller to keep track of resources. The central controller communicates with the resources at frequent intervals to check the status of the resources. To detect the exact status of resources at any given instance, the central controller frequently queries the various components of the inventory management system. Examples of components of the inventory management system include processors, sensors, databases, and so forth. These components of the inventory management system do not share information and knowledge with each other, thus raising redundant alerts to the central controller.

Frequent queries from the central controller and alerts from the various components create an overhead of information at the central controller. Therefore, there is excessive data and communication with considerable redundancy in the management system. Further, the management of excessive individual data is highly time-intensive. Moreover, processing excessive data requires high-end computing devices and makes the management system uneconomical.

Manufacturing policies are often set as part of planning phase and are not updated continuously in response to the low level fluctuations or variability, such as demand, costs response times, operator and equipment status, etc., that occur on the floor of a manufacturing or distribution facility. Not responding to such fluctuations can have a negative impact on holding costs of work in progress, work flow and cycle times.

Radio-frequency identification (RFID) systems that use RFID tags attached to an object (a product or component) are useful for tracking movement of objects during shipping, but do not provide real time manufacturing information, distribution floor scheduling information or process information.

Generally, the use of RFID tags can provide a large amount of individual data, but that data is not used for autonomous decision making. Non-emergent systems, such as databases may be alerted unnecessarily to changes in the environment because devices within the system do not share information and do not learn from one another.

A centralized system, such as a central controller that tracks inventory, may communicate with (query) a particular RFID device many times in a given time period to detect if a change has occurred. However, there is currently no way for the centralized system to know how often to the query the device.

### BRIEF DESCRIPTION OF THE FIGURES

The accompanying figures, in which like reference numerals refer to identical or functionally similar elements throughout the separate views and which together with the detailed description below are incorporated in and form part of the specification, serve to illustrate further various embodiments and to explain various principles and advantages all in accordance with the present invention.

FIG. 1 is a diagrammatic representation of an apparatus for pallet-workstation and workstation-workstation communication in accordance with certain embodiments of the invention.

FIG. 2 is a flow chart of a method consistent with certain embodiments of the invention.

FIG. 3 is a flow chart of a further method consistent with certain embodiments of the invention.

FIG. 4 is a flow chart of a still further method consistent with certain embodiments of the invention.

FIG. 5 is a block diagram of an apparatus for pallet-workstation and workstation-workstation communication in accordance with certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to supply chain management.

Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and stored program instructions that control the one or more processors to implement, in conjunction with certain non-processor circuits, some, most, or all of the functions of communication and processing described herein. The non-processor circuits may include, but are not limited to, a radio receiver, a radio transmitter, signal drivers, clock circuits, power source circuits, sensors and user input devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

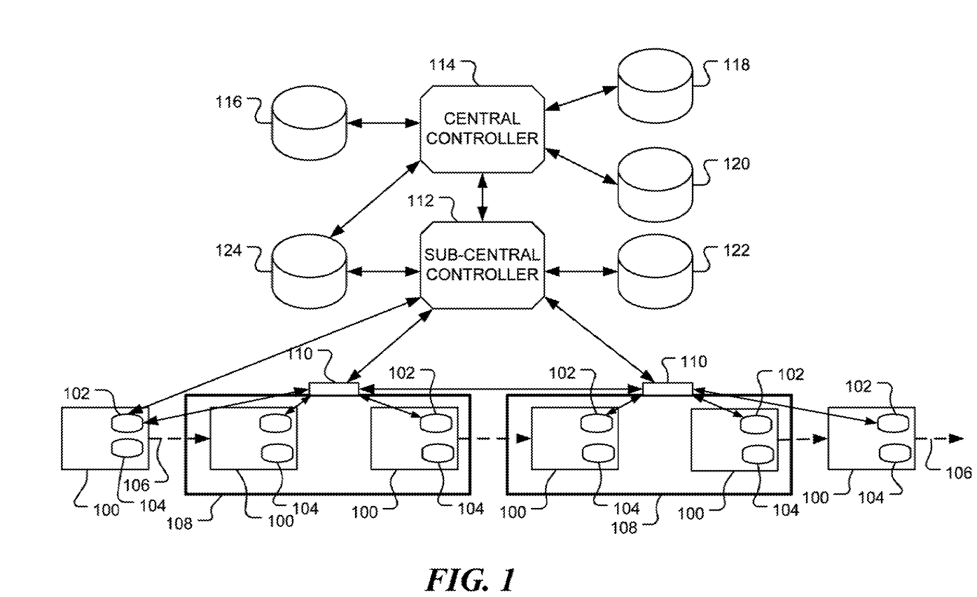

FIG. 1 is a block diagram of an apparatus for supply chain management utilizing pallet-workstation and workstation-workstation communication in accordance with certain embodiments of the invention. Referring to FIG. 1, a number of pallets 100 are equipped with intelligent electronic devices 102, referred to in the sequel as pallet devices, and one or more sensors 104. A pallet 100 may be any kind of transport structure, such as a shipping pallet, flat structure, box-like structure, tote, or buffer, which holds items and facilitates movement of resources (components, raw materials, goods, etc.). In the sequel, the term ‘pallet’ is taken to include all such structures. A pallet device 102 may be an electronic device including a processor, a transceiver and a memory. Each of the pallet devices 102 may include a communication unit, using which the pallet devices can communicate with each other and the one or more resources. Examples of wireless communication equipment that the communication unit may include, but is not limited to, a Global Positioning System (GPS), a Wireless Local Area Network (WLAN), an active or passive Radio Frequency Identification (RFID) tag, and so forth.

A pallet 100, and its supported resources, moves along a path or track 106 between various workstations 108 of a manufacturing or distribution supply chain. For example, the pallet 102 may support a work in progress, and the workstations may include flex-picking, pre-working, flexing, labeling and/or packing workstations of a manufacturing facility. Pallets may be stored or buffered at the entrance and/or exit of each workstation, so multiple pallets may occupy a single workstation at a given time.

A pallet may support raw materials that are input to a first workstation of a series of workstations, or it may support partially completed products that are transported between workstations performing consecutive operations, or it may support completed products that are packed ready for shipping. The workstations may operate to move goods from one pallet to another, or to modify items on a pallet. A workstation may receive pallets from a single source or from multiple sources.

In accordance with some embodiments, each of a plurality of pallet devices is operable to communicate with the one or more resources associated with it using a wireless communication link. Further, the pallet devices may communicate with one another. Still further, the workstations may be equipped with intelligent devices, referred to as workstation devices, to enable the pallet devices to communicate with the workstation devices and the workstation devices to communicate with one another.

In turn, the workstation devices are operable to communicate with a sub-central controller 112. The sub-central server controller, which may be a computer server for example, provides real-time management of supply chain policies, such as manufacturing/distribution center floor policies relating to work in progress and throughput, for example. In a manufacturing environment, the sub-central controller 112 may be used to manage order fulfillment from raw materials to packing. It takes input from decisions and data resulting from collaboration on the line (i.e. workstation-workstation and/or pallet-workstation interaction) and either makes local decisions or passes data up to a central controller 114 for global decision making. The central controller 114 communicates with one or more databases, such as a product information database 116, an inventory and receiving database 118 and an order database 120. The sub-central server communicates with one or more databases, such as work station database 122 and distribution/manufacturing floor database 124, to make local decisions or pass decisions upwards. The central controller 114 may also communicate with the distribution floor database 124.

The central controller may oversee several groups of workstations, each having an associated sub-central controller.

Pallet-pallet, pallet-workstation and workstation-workstation communication allows information to be collected regarding the state of the manufacturing/distribution floor. The devices are operable to collaborate with one another and to use rules to make decisions. These decisions may be used to modify the operation of the supply chain, either by affecting the operation of workstations and their operators on the floor directly, or by transferring information to the sub-central controller for higher-level decision making.

In one embodiment, the sub-central controller manages and links work in progress with an order ID. It is operable to make local decisions based on data and alerts from pallet and/or workstation devices and may pass information to the central controller for more global decision making (such as cross-domain or cross-functional decisions). Thus, the apparatus enables both distributed and hierarchical decision making.

The apparatus enables products to be re-routed based on a real-time policy, enables operators to be redirected to other workstations, and allows flow of work-in-progress to be adjusted to improve cycle time or reduce holding costs.

In accordance with some embodiments, the pallet device 102 is able to obtain information regarding the resources loaded on the pallet. This information may be obtained from one or more sensors 104 mounted on a pallet 100, and/or from radio frequency identification (RFID) tags coupled to the resources loaded on the pallet. The resources may be, for example, components, sub-assemblies, raw materials, etc. The sensors 104 sense different parameters of the resources loaded on the pallet 102. Examples of sensors include, but are not limited to, a weight sensor, a volume sensor, and a temperature sensor. The pallet device is operable to communicate with a sensor 104 that is mounted on the pallet 100. The RFID tags enable wireless communication with the pallet device 102. Thus, a pallet device is associated with a pallet in the supply chain. Similarly, a pallet is associated with one or more resources supported by the pallet.

The pallet device may update its information in response to detected events. For example, an event could be a change in a sensed value, a time-related condition, receipt of a wireless message, or a sensed value meeting a criterion. Examples of sensed values include, but are not limited to, weight, physical location, temperature, pressure and chemical presence. Examples of time-related conditions include, but are not limited to, a periodic condition, a duration of time elapsed since the occurrence of some other event, and a real time value, such as 3:35 PM. Examples of receipt of a wireless message include, but are not limited to, a message from another pallet device, a message from a workstation device and a message from a server.

Status information may be reported by a pallet device 102 to one or more workstation devices 110, to the sub-central controller 112 and/or to one more other pallet devices 102. The status information of a pallet is related to the status of each of the resources loaded on the pallet. The status information of a pallet can include, but is not limited to, physical conditions, environmental conditions, and physical attributes of the resources loaded on the pallet. The status information of a pallet can be acquired by communicating with the pallet, and/or with other pallets of the plurality of pallet devices and/or with at least one system server, depending on a type of embodiment or circumstances. In order to determine the status information of a pallet 100, the pallet device 102 associated with the pallet can communicate with the resources on the pallet to acquire the status information of the resource loaded on the pallet. Acquiring the status information may also require communication with one or more of the plurality of sensors coupled to one or more of the plurality of pallets. The one or more sensors 104 can sense the physical conditions of the pallet 100. Examples of physical conditions include, but are not limited to, weight, volume and temperature.

In accordance with some embodiments, the pallet device may acquire the status information of the resource by obtaining a resource identifier from the resource by wirelessly communicating with a resource identifier device. An example of a resource identifier device is an RFID tag. An RFID tag can contain resource identifiers with information about the one or more resources. A resource identifier may comprise, but is not limited to, one or more of a product name, a product ID, a manufacturing date, an expiration date, a weight, or a set of physical dimensions. A resource identifier may be wirelessly communicated to at least one system server to obtain physical or other attributes associated with one or more resources. For example, the pallet device 102 communicates a resource identifier containing information such as a product name and a weight to the server to obtain information about the physical dimensions corresponding to the resource. In accordance with some embodiments, the pallet device 102 communicates a resource identifier to at least one system server in order to obtain inventory lists associated with one or more pallets and the resource identifier.

Thus, a pallet device is operable to collect and process information from resources on the pallet. In addition, the pallet device is operable to acquire information, such as the expected parameters of the resources on the pallet, from databases. This enables the pallet device to make rule-based decisions regarding the resources. These decisions, together with processed information, may be communicated to other pallet devices, to workstation devices and/or to the sub-central controller.

RFID tags are not required at a component level. Instead, database communication product may be based on products.

Some examples of application of the apparatus are now described.

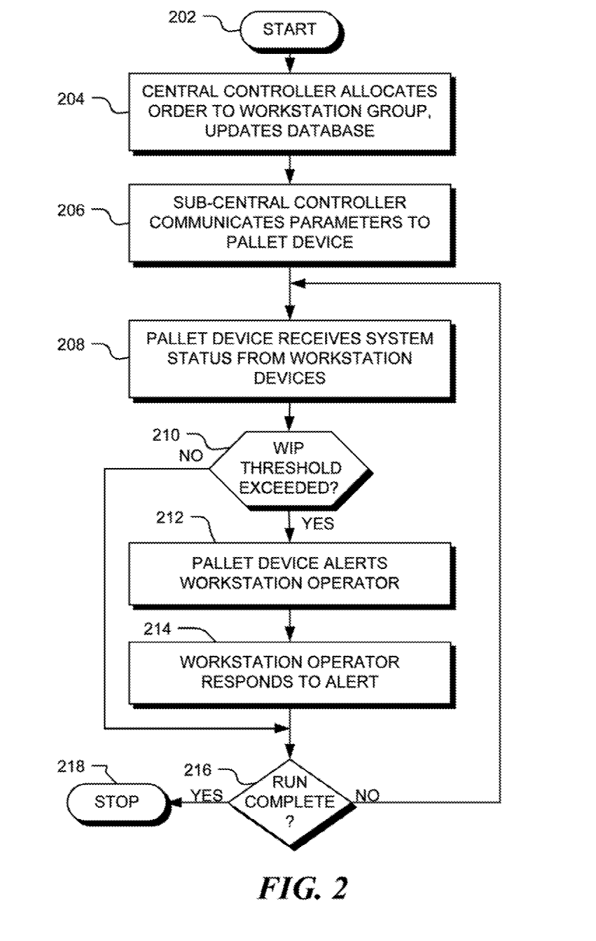

FIG. 2 is a flow chart of a method consistent with certain embodiments of the invention. In this example, following start block 202, the central controller allocates order material to a group of workstations including customer required ship data, on a manufacturing floor and stores the order identification number, customer required shipping date, etc., to that allocation in the distribution/manufacturing floor database at block 204. At block 206, the sub-central controller communicates parameters, such as a work in progress threshold at a workstation or a work in progress threshold in the system, to the pallet device of a raw material pallet at the start of a line of workstations. These parameters aid in reducing overall manufacturing cycle times and holding costs, for example. Through communication with the workstation devices, the raw material pallet device learns parameters of the system status (such as the number of items and work in progress in the system) at block 208. If the work in progress threshold is exceeded, as depicted by the positive branch from decision block 210, the raw material pallet alerts the operator of the first workstation at block 212. At block 214 the operator responds to the alerts by, for example, remaining idle at the workstation or by attending an overloaded workstation if capacity exists. At decision block 216, a check is made to determine if the run is complete. If not, as indicated by the negative branch from decision block 216, flow returns to block 208, where status information is updated. Otherwise, as indicated by the positive branch from decision block 216, the process terminates at block 218. At the end of the line of workstations, a pallet device of a shipping pallet queries the RFID tags on the pallet and/or one or more sensors on the pallet and confirms the information with the product database. The pallet device then informs the sub-central controller that the material is ready for shipping. The sub-central controller collects the contents from the shipping pallet and indicates, via a flag for example, that the order is now ready for shipping and updates appropriate data base.

A workstation device may communicate with pallet devices. In particular, a workstation device can communicate with the devices of pallets in the proximity of the workstation, such as work in progress pallets or pallets in the input or output buffers of the workstation. In addition, the workstation device is operable to acquire information, such as work in progress thresholds for the workstation or for the system, from databases. This enables the workstation device to make rule-based decisions regarding the flow of material or pallets. These decisions, together with processed information, may be communicated to other workstation devices, to pallets and/or to the sub-central controller. For example, if each workstation device communicates its number of pallets, the sub-central controller can determine the total number of pallets currently in the system. In one embodiment, a workstation includes sensors and RFID readers. Sensors are used to detect station capacity and/or availability. For example, a workstation may contain a number of benches or fixtures for holding or processing product. Using sensors or RFID tags, a workstation can detect the current station capacity and the number of items being processed (the workstation availability) and report to pallets.

In one embodiment, an operator can register with workstation via RFID tag on a handheld Mobile Device. This enables the workstation to determine the number of operators currently at the workstation station. If an operator is registered with a particular fixture, they are not available. Otherwise, the operator is idle and can be alerted to move to another station if needed, depending on the operator's skill set recorded in a workstation database.

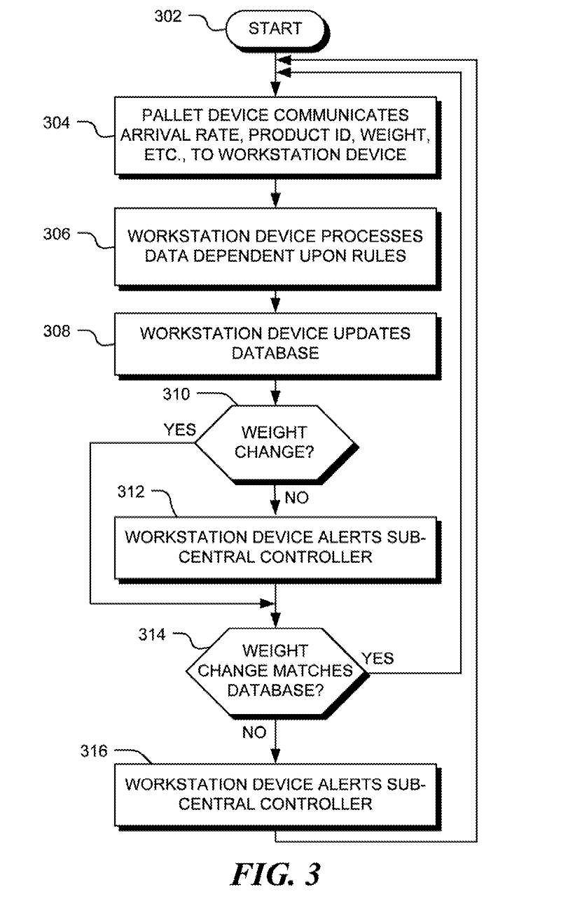

FIG. 3 is a flow chart of a further method consistent with certain embodiments of the invention. In this example, the apparatus is used to reduce the effects of operator and/or equipment variability, and to enhance reliability and availability prediction in a manufacturing environment. Following start block 302, a raw material pallet device communicates arrival rate, product name, weight, etc. to a workstation device of a first workstation (such as a flex picking workstation) at block 304. Based on the workstation information (and dependent on the product in flow), the workstation device, at block 306, establishes average processing time and average departure rate from the workstation, together with associated variability and cycle times. At block 308, the workstation device updates the workstation database with cycle times, throughput rates, etc. via communication with the sub-central controller. Input and output weights of pallet contents can be determined through communication with the pallets. If the weight does not change, as indicated by the negative branch from decision block 310, the workstation device may alert the sub-central controller, at block 312, that the workstation may have a problem and that there is a potential of down-time. This helps to predict product availability. The workstation device may retrieve expected weight of pallets exiting the workstation from the workstation database and retrieve the actual weight from the pallet device. If a pallet weight, or weight change, does not match the database, as indicated by the negative branch from decision block 314, the workstation device (and/or pallet device) can alert the sub-central controller of a potential reliability problem at block 316. Otherwise, flow returns to block 304, where pallet information is updated.

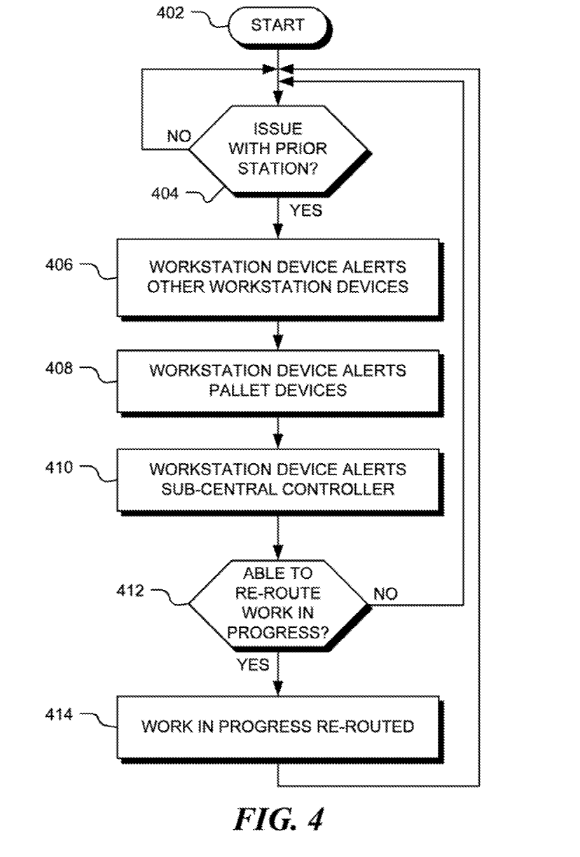

FIG. 4 is a flow chart of a still further method, consistent with certain embodiments of the invention, in which the apparatus is used to maximize product throughput in a manufacturing or distribution environment. Following start block 402 in FIG. 4, if a workstation device detects availability issues with a prior workstation, as indicated by the positive branch from decision block 404, the workstation device alerts other workstation devices at block 406. Additionally, the workstation device alerts the raw material and shipping pallet devices at block 408. At block 410, the workstation device alerts the sub-central controller. Together, the workstation devices determine if work in progress can be re-routed. If it is possible to re-route the work in progress, as depicted by the positive branch from decision block 412, the work in progress is re-routed at block 414 and flow returns to block 404. Otherwise, as depicted by the negative branch from decision block 412, flow returns to block 404.

In one embodiment, the sub-central controller reports flexibility in workstation sequence for a particular product, resulting in re-routing of product through stations. For example, the workstations report capacity and availability to pallet devices to inform the operator of the number of items that could be transported to workstation based on the workstation's current status (work in progress, workstation capacity and workstation availability, for example). After the work station receives a description of the routing flexibility, the pallet devices that are in a holding state request that an appropriate number of products and resources be re-routed from appropriate workstations or holding buffers/pallets associated with the workstation.

Multicast messages may be transmitted to pass information to multiple devices (pallet or workstation devices) at the same time.

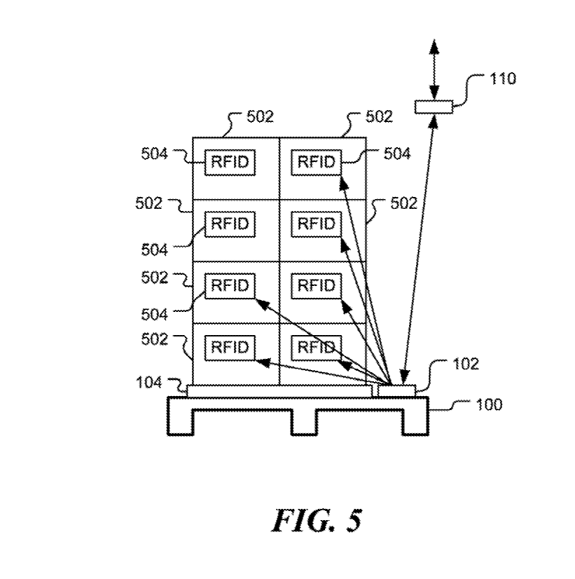

FIG. 5 is a block diagram of a loaded pallet 100. In this embodiment, an intelligent device 102 is located on the pallet 100 and is able to communicate with a further intelligent device 110 located at a workstation. The pallet supports the items or goods 502 being transported to and from workstations. It is to be understood, as described above, that the term ‘pallet’ is used to describe any structure that facilitates the holding and transporting of single or multiple items, and is taken to include boxes, crates, carts, totes, buffers, etc. The goods may be manufactured products, components, raw materials etc. The pallet device 102 is also able to communicate with radio-frequency identification (RFID) tags 504 attached to the individual items 502 of the transported goods. This communication may take place when the pallet is first loaded, when the pallet device is contacted by the workstation device 110, when the pallet is unloaded or at other times during transit. The RFID tag includes computer readable memory that may be used to store information relating to the single item to which it is attached. The RFID tag may be passive or active.

Events may be triggered by a sensor on the pallet or a sensor that is part of RFID tag (504). For example, a temperature decrease of a package (502) may be used to trigger the event of releasing pallet to proceed.

The sensor 104 is used to measure a physical property of the loaded goods and is operable to communicate with the pallet device 102 using a wired or wireless link. In one embodiment, the sensor is a weight sensor for example. A pallet may use multiple sensors.

In some embodiments, the pallet device includes a computer readable memory that is readable by a processor of the device and is able to store information relating to the pallet (and its history) and the goods on the pallet. The information may include, for example, the total number of products on the pallet, the weight of product, the types of products and the total number of products of each type. The memory may also be used to store software instructions for control of the intelligent device.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing operation of a supply chain having a sub-central controller, a plurality of pallets, a plurality of pallet devices each associated with a pallet, a plurality of workstations and a plurality of workstation devices each associated with a workstation, the method comprising:
a workstation device, of the plurality of workstation devices, communicating with a pallet device of the plurality of pallet devices to acquire pallet information;
the workstation device processing the pallet information based upon rules provided by the sub-central controller; and
the workstation device acting on the processed pallet information to modify the operation of the supply chain.

2. A method in accordance with claim 1, further comprising:
the workstation device communicating with other work stations devices of the plurality of workstation devices to determine the status of the supply chain; and
the work station device modifying operation of the supply chain dependent upon the status of the supply chain and rules provided by the sub-central controller.

3. A method in accordance with claim 1, further comprising:
a pallet device of the plurality of pallet devices communicating with associated pallet resources to acquire pallet load information; and
the pallet device processing the pallet load information based upon rules provided by the sub-central controller to establish the pallet information.

4. A method in accordance with claim 3, further comprising:
the pallet device acting on the processed pallet load information to modify the operation of the supply chain.

5. A method in accordance with claim 1, further comprising the sub-central controller accessing at least one database containing information related to the supply chain.

6. A method in accordance with claim 5, further comprising the sub-central controller modifying operation of the supply chain dependent upon information from the at least one database and dependent upon information received from at least one workstation device of the plurality of workstation devices.

7. A method in accordance with claim 1, further comprising a pallet device of the plurality of pallet devices obtaining the pallet information by communicating with a pallet sensor to acquire pallet load information, wherein the pallet sensor is at least one sensor selected from the group of sensors consisting of weight, physical location, temperature, pressure and chemical presence sensors.

8. A method in accordance with claim 1, wherein the supply chain further comprises a central controller operable to communicate with a plurality of sub-central controllers, the method further comprising:
the central controller processing information from a plurality of sub-central controllers dependent upon a set of rules to generate processed sub-central information; and
modifying the operation of the supply chain dependent upon the processed sub-central information.

9. A method in accordance with claim 1, wherein the workstation device, of the plurality of workstation devices, communicating with the pallet devices to acquire pallet information utilizes a wireless communication link.

10. A method in accordance with claim 1, wherein the workstation device acting on the processed pallet information to modify the operation of the supply chain comprises the workstation device alerting an operator of a workstation.

11. A method in accordance with claim 1, wherein the pallet comprises a transport structure select from the group of transport structures consisting of a shipping pallet, a tote, a buffer, a cart, a crate and a box.

12. A method in accordance with claim 1, further comprising:
a workstation device, of the plurality of workstation devices, communicating with a communication device of an operator stationed at the workstation to determine the number and identity of operators at the workstation;
the workstation device registering the operator in a workstation database.

13. A method in accordance with claim 12, further comprising determining operator availability dependent upon operator registered in the workstation database.

14. A method for managing operation of a supply chain having a sub-central controller, a plurality of pallets, a plurality of pallet devices each associated with a pallet, a plurality of workstations and a plurality of workstation devices each associated with a workstation, the method comprising:
a pallet device, of the plurality of pallet devices, communicating with the workstation devices to acquire workstation information;
the pallet device processing the workstation information based upon rules provided by the sub-central controller; and
the pallet device acting on the processed workstation information to modify the operation of the supply chain.

15. A method in accordance with claim 14, wherein the pallet device acting on the processed workstation information to modify the operation of the supply chain comprises the pallet device alerting an operator of a workstation.

16. A method in accordance with claim 14, wherein the pallet device acting on the processed workstation information to modify the operation of the supply chain comprises the pallet device requesting that supply chain items be re-routed from appropriate workstation based on a current state of the workstations.

17. An apparatus for supply chain management comprising:
a plurality of workstations;
a plurality of workstation devices, each associated with a workstation of the plurality of workstations;
a sub-central controller operable to communicate with the plurality of workstations; and
a plurality of pallet devices each associated with a pallet for carrying supply chain items;
wherein a workstation device of the plurality of workstation devices is operable to:
communicate the plurality of pallet devices to obtain pallet information;
communicate with the sub-central controller to obtain a set of rules;
process the pallet information in accordance with the set of rules to produce processed information; and
modify operation of the supply chain dependent upon the processed information.

18. An apparatus in accordance with claim 17, wherein a workstation device of the plurality of workstation devices is operable to receive workstation information from workstation devices of the plurality of workstation devices, and to modify operation of the supply chain dependent upon the workstation information.

19. An apparatus in accordance with claim 17, wherein a workstation device of the plurality of workstation devices is operable to alert the sub-central controller dependent upon the pallet information.

20. An apparatus in accordance with claim 17, wherein a workstation device of the plurality of workstation devices is operable to alert the sub-central controller dependent upon operator information.

21. An apparatus in accordance with claim 17, further comprising a central controller operable to receive sub-central controller information from a plurality of sub-central controllers and to modify operation of the supply chain dependent upon the sub-central controller information.

22. An apparatus in accordance with claim 21, further comprising a database accessible by the sub-central controller and by the central controller.

23. An apparatus in accordance with claim 17, wherein a workstation device of the plurality of workstation devices comprises a processor, a transceiver; and a memory.

24. An apparatus in accordance with claim 17, further comprising a plurality of RFID readers, each associated with a workstation of the plurality of workstations.

25. An apparatus in accordance with claim 17, further comprising a plurality of sensors, each associated with a workstation of the plurality of workstations, operable to sense number of supply chain items at the workstation.

26. An apparatus in accordance with claim 17, further comprising:
a sensor associated with a pallet of the plurality of pallets,
wherein the sensor is operable to sense a value of a physical property of at least one item supported by the pallet and communicate the value to a pallet device associated with the pallet, and wherein the pallet information is dependent upon the value.

27. An apparatus in accordance with claim 26, wherein the sensor is at least one sensor selected from the group of sensors consisting of weight, physical location, temperature, pressure and chemical presence sensors.

28. An apparatus in accordance with claim 17, further comprising:
a radio-frequency identification tag associated with an item supported by a pallet of the plurality of pallets and operable communicate item information to a pallet device associated with the pallet,
wherein the pallet information is dependent upon the item information.

29. An apparatus in accordance with claim 17, wherein a pallet device of the plurality of pallet devices is operable to communicate with the sub-central controller.

30. An apparatus in accordance with claim 17, further comprising a database accessible by the sub-central controller.
